(19) United States
(12) Patent Application Publication
(10) Pub. No.: US 2008/0169922 A1
(43) Pub. Date: Jul. 17, 2008

(54) PORTABLE DETERRENT ALARM SYSTEM

(76) Inventor: Peter Alan Issokson, Garland, TX (US)

Correspondence Address: HOWISON & ARNOTT, L.L.P, P.O. BOX 741715, DALLAS, TX, 75374-1715, US

(21) Appl. No.: 12/014,002

(22) Filed: Jan. 14, 2008

Related U.S. Application Data
(60) Provisional application No. 60/885,174, filed on Jan. 16, 2007.

(51) Int. Cl. G08B 13/00

(52) U.S. Cl. 340/541

(57) ABSTRACT

A system and method for the detection of an intruder in an area under construction is disclosed. The self-contained portable deterrent alarm system includes a plurality of means for detecting an intruder and broadcasting at least one of an audible siren or audible voice alarm. The system and method further include, in response to receiving a triggering signal, establishing a telephone communication to a monitoring center to report an intrusion at the construction site. The system is adapted for quick install, removal and relocation to an alternate construction area.

### CROSS-REFERENCE TO RELATED APPLICATION

This application claims priority to U.S. Provisional Application for Patent Ser. No. 60/885,174 filed Jan. 16, 2007, and entitled “PORTABLE DETERRENT ALARM SYSTEM” (Atty. Dkt. No. ISSK-28,159), the specification of which is incorporated herein by reference.

### TECHNICAL FIELD OF THE INVENTION

This invention is related in general to deterrent alarm systems using the recording of audio sounds and the recording of audio, video, images and other information to deter the commission of a crime at a location. In addition, this invention also provides for the broadcast of audio, video, and images to a central location to alert authorities that a crime is in progress.

### BACKGROUND OF THE INVENTION

As more construction commences to keep pace with the ever growing population, theft at construction sites also has been rising. The inability to keep constant vigilance over a building or home under construction has enabled many criminals to access highly valuable construction materials.

With the increase in value of the materials, such as copper used as electrical conductor and in piping, and the highly pilferable nature of the construction materials, many criminals are stealing these materials after the construction foreman and the contractors are away from the construction site. Many construction foremen have been forced to pay high costs to have a security service or an individual monitor the construction site during times when construction is not occurring while others have opted to take the chance and pass on any losses that occur.

A building or home under construction often does not have a lockable door throughout most of the construction period. Additionally, a building or home under construction may have walls that are incomplete revealing only the studs or beams that do not prevent a person walking between. Windows may or may not be installed as well. As a result, under the cover of night, when construction crewmembers are least likely to be present, a criminal can gain ready access to any part of the structure under construction from any direction. Thus, the criminal can also escape in any direction as well.

There are many security systems on the market that provide effective deterrents for buildings that are already constructed and, usually, already occupied. However, these systems are not readily adaptable to an area in which the building has open walls, no doors or windows, and sometimes, not even a roof. Since the walls are incomplete and doors and windows usually not installed, many security systems cannot effectively create a secure perimeter required for deterrence and enforcement. A motion sensor could easily read past the area to be protected and sense the motion of wildlife or innocent pedestrians instead. Impact sensors that rely on the breaking of glass and contact sensors that rely on the opening of a door or window are ineffective as no glass or doors may be present at the time a criminal seeks to commit the theft. What is needed is a system to provide deterrence to theft to a site under construction or any other site needing security where a large, built-in system is not feasible.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a block diagram of the alarm control unit in accordance with some embodiments of the invention;

FIG. 2 illustrates a block diagram of an exemplary portable deterrent alarm system in accordance with some embodiments of the invention; and

FIG. 3 illustrates an exemplary flow chart of the operation of a portable deterrent alarm system in accordance with some embodiments of the invention.

### DETAILED DESCRIPTION OF THE INVENTION

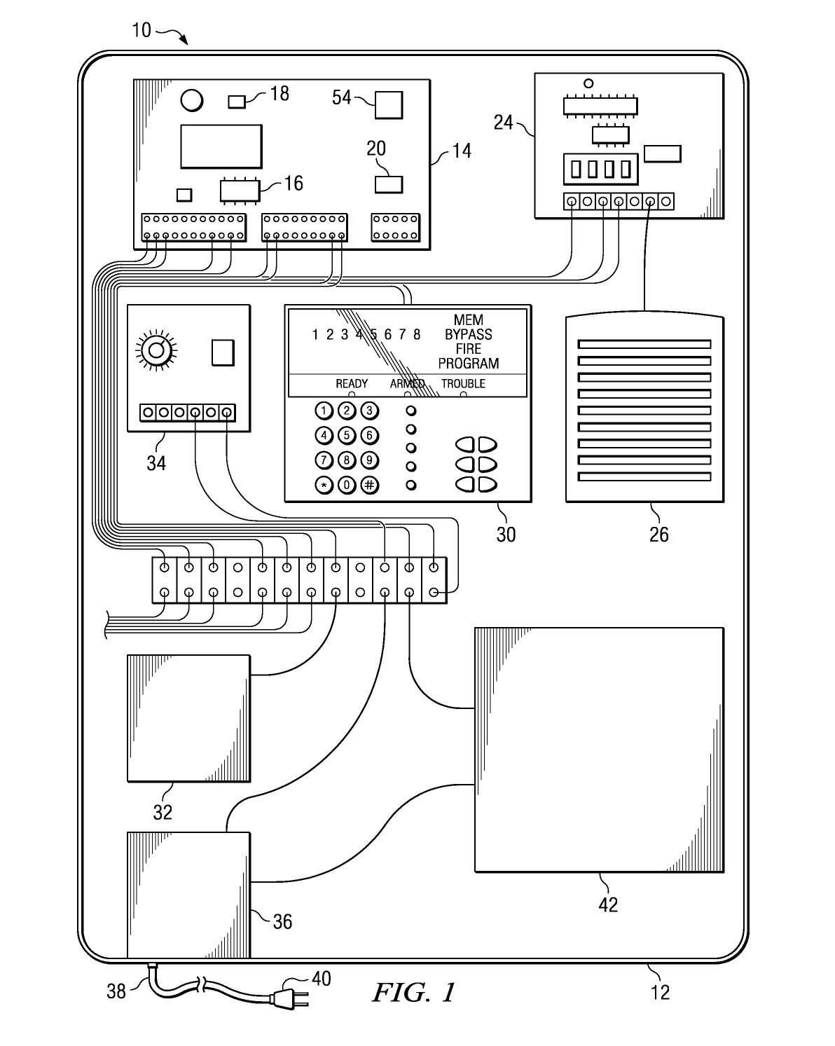

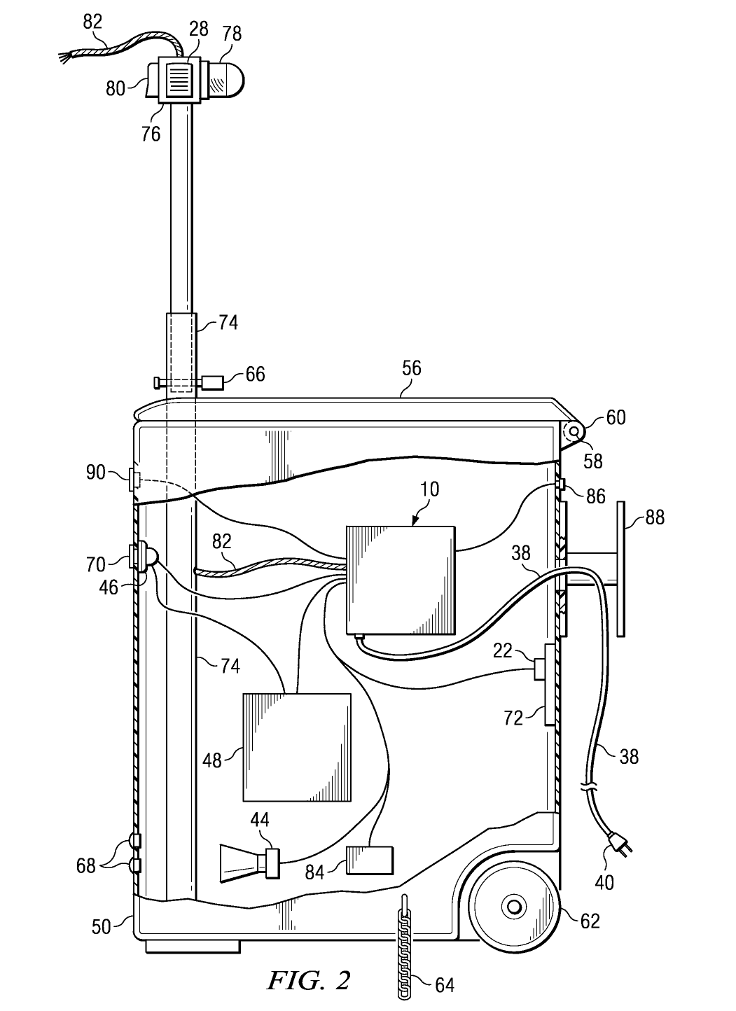

Referring now to FIG. 1, there is illustrated a block diagram of one embodiment of a control panel in accordance with some embodiments of the present invention. A system generally is directed toward a deterrent alarm system alarm control unit 10 that can be placed in a standard, flush-mount, in-wall box (not shown) that can be mounted in-between two stud members in a building under construction. The alarm control unit 10 can be temporarily placed within the in-wall box during construction. The alarm control unit 10 can later be removed upon construction completion and replaced with a permanent security system as will be described in further detail herein. The alarm control unit 10 may also be converted to a permanent security system at the completion of construction. Additionally, the alarm control unit 10 can be installed in a portable housing (reference number 50 described herein below with respect to FIG. 2) as a portable deterrent alarm system.

The alarm control unit 10 can be placed within a panel box 12. The panel box 12 can be similar to the in-wall box or similar to an electrical panel box as is known in the art. Artisans of skill will appreciate that the particular size, shape and material of the panel box is not limited to that shown in FIG. 1. The panel box 12 can be of any size and shape necessary to contain the components of the alarm control unit 10. The panel box 12 can have a door (not shown) hinged to the panel box 12. Additionally, the panel box 12 can be constructed such that, upon placement of the alarm control unit 10 inside the panel box, the panel box 12 can be sealed as a closed container. In the latter configuration, the alarm control unit 10 must either be programmed to perform the theft deterrent functions prior to closing the panel box 12 or the alarm control unit 10 must be programmable with an external remote keypad (reference number 32 discussed in further detail herein below).

The alarm control unit 10 includes an alarm control board 14. The alarm control board 14 can control the functions of the portable deterrent alarm system. The alarm control board 14 is the main processing board within the alarm control unit 10. The alarm control board 14 can be a standard alarm circuit board as is known within the industry or a processor circuit board designed in accordance with a standard alarm board and capable of operating the peripheral attachments and corresponding functions described below. The alarm control board 14 can include a microprocessor 16. The alarm control board 14 can further include a memory or other computer readable medium 18. In the present example, a computer readable medium is any electronic, magnetic, electromagnetic, optical, electro-optical, electromechanical, and/or other physical device that can contain, store, communicate, propagate, or transmit a computer program, software, firmware, or data for use by the microprocessor 16 or other computer-related system or method. The microprocessor 16 is in data communication with the memory 18. The memory 18 can contain instructions for use by the microprocessor 16. The instructions are configured such that the microprocessor 16 can perform a series of functions as described herein below with respect to the functions of the portable alarm deterrent system.

The alarm control board 14 can include a telephone communication device 20. The telephone communication device 20 may also be a separate unit, not included as part of the alarm control board 14 (telephone communication device 20 as a separate unit is not illustrated). The telephone communication device 20 can be a standard modem, or other telephone connection device, that is operable to establish a telephone communication with a monitoring center via a plain old telephone system (POTS) connection. A POTS connection could also be considered a physical land-line. Additionally, the telephone communication device 20 can be a wireless modem, such as a GSM device with a Subscriber Identification Module (SIM) card. If the telephone communication device 20 is a wireless modem, the telephone communication can be established with the monitoring center via a wireless transmission (i.e. via the cellular, wireless telephone network as part of the public switched telephone network).

Additionally, a back-up wireless telephone device 22 (discussed herein with respect to FIG. 2) can be used in the event of a failure, or interruption, of the telephone communication from the telephone communication device 20. In the event that the telephone communication device 20 cannot establish a telephone communication, or in the event that an established telephone communication is interrupted, the microprocessor 16 can utilize the backup wireless communication device 22 to establish a telephone communication with the monitoring center. For example, if the POTS land line is severed by an intruder, the microprocessor 16 will be unable to establish a telephone communication via the telephone communication device 20. The microprocessor 16, using some of the instructions stored in the memory 18, can detect that a communication is either not available via the telephone communication device 20 or that an established communication has been interrupted. The microprocessor 16 can, in response to the detection of the telephone communication failure (such as by detecting the absence of a “tone” on the POTS line), can utilize the backup wireless telephone device 22 to establish the telephone connection to the monitoring center. In an alternate example, the telephone communication device 20 is a wireless modem that fails. Again, the microprocessor 16 is operable, using some of the instructions stored in the computer readable medium, to detect the failure of the telephone communication device 20. The microprocessor 16 can, in response to the detection of the failure, use the backup wireless telephone device 22 to establish a telephone communication with the monitoring center. Artisans of skill will recognize that the foregoing are illustrations of possible scenarios and should not be construed as limiting.

The alarm control board 14 is in electrical connection with a voice module 24. The voice module 24 can be a four-channel voice module that is capable of recording and playing multiple voices and a multitude of different sound effects. The voice module 24 can be in data connection with the alarm control board 14 and memory 18. Alternatively, the voice control module 24 can include a separate memory (not specifically illustrated). The memory 18, or a memory optionally included on the voice control module 24, can store a pre-programmed alarm voice or can be programmed with a user defined voice. For example, the pre-programmed alarm voice could say “ALERT-ALERT, THE POLICE HAVE BEEN NOTIFIED.” Additionally, a user could program the voice to say “THIS IS THE PROPERTY OF ABC CONSTRUCTION, THE POLICE HAVE BEEN NOTIFIED AND WILL BE HERE SHORTLY.” Artisans of skill will appreciate that many possible voice alarms can be pre-programmed or recorded. The user can record the voice via a programming function discussed herein below with respect to the functions of the portable deterrent system.

The voice module 24 can be electrically coupled to an internal siren 26. In other embodiments, the internal siren 26 can be electrically coupled to the microprocessor 16. The internal siren 26 is operable to broadcast a loud pitched noise ranging between, for example 80 decibels (dB) and 135 dB. Additionally, an external siren 28 (illustrated in FIG. 2) can be electrically coupled (e.g., in parallel) with the internal siren 26. For example, if the internal siren is electrically coupled to the voice module 24, the external siren 28 may be electrically coupled to the voice module 24. However, if the internal siren 26 is electrically coupled to the microprocessor 16, then the external siren 28 may be electrically coupled to the microprocessor 16. Connecting the external siren 28 in parallel with the internal siren 26 enables the portable deterrent alarm system to continue broadcasting a siren alarm even if an intruder damages or destroys the external siren 28 because the internal siren 26 will continue to broadcast the siren.

As stated herein above, the alarm control unit 10 must be programmed. In order to program the alarm control unit 10, the alarm control unit 10 includes a keypad controller (“keypad”) 30. The keypad 30 is electrically coupled to the alarm control board 14. More specifically, the keypad 30 provides programming instructions for the microprocessor 16. The microprocessor 16 can store the programming instructions in a portion of the memory 18. The microprocessor 16 can also be immediately responsive to at least a portion of the programming instructions. Additionally, the keypad 30 can provide arming and disarming functions for the portable deterrent alarm system.

The keypad 30 can be mounted inside the alarm control unit 10. In an alternate embodiment, the keypad can be mounted outside the panel box 12 of the alarm control unit 10. Additionally, a remote keypad (not illustrated) can be used to program the alarm control unit 10. In order to use the remote keypad, the alarm control unit 10 can include an external keypad remote controller (“keypad remote”) 32. The keypad remote 32 provides an interface to facilitate the use of the remote keypad. For example, when the alarm control unit is in a sealed panel box 12 and programming must be performed, the remote keypad can transmit signals to the keypad remote 32. The remote keypad can transmit the programming signals to the keypad remote 32 via RF signals, WiFi signals, infrared or any wireless method known in the art or developed in the future. Alternatively, a control port, or terminal 90, can be provided such that a direct wired-connection can be established between the remote keypad and keypad remote 32. In such a configuration, the terminal 90 is provided on the exterior of the alarm control unit 10. Additionally, if the alarm control unit 10 is contained in the housing 50 (discussed herein with respect to FIG. 2), the terminal 90 could be provided on the front surface of the housing 50. The terminal 90 has an electrical connection to the keypad remote 32. In an alternate embodiment, the terminal 90 can have a direct connection to the alarm control board 14. The remote keypad can have a plug that is capable of establishing an interface connection (i.e. male plug to a female receiving terminal) to the terminal 90. The keypad remote 32 is in electrical and data communication with the alarm control board 14. Therefore, the keypad remote 32 can transmit the programming signals received from the remote keypad to the alarm control board 14 and, ultimately, provide programming instructions to the microprocessor 16. As such, a user (i.e., a construction superintendent, owner, or contractor) can use the remote keypad to remotely program, arm and disarm the portable deterrent alarm system without the need to access the internal keypad 30. Additionally, the keypad 30 and remote keypad can be utilized, through a user keyed input sequence, to display all activity (i.e., the times when the system was armed and disarmed and the person whose code was used to arm and disarm the system) that has occurred during a specified time period, typically up to two (2) weeks.

In an alternate embodiment, the alarm control unit 10 includes a timer 34. The timer 34 is electrically coupled to the alarm control board 10. More specifically, the timer 34 provides time duration instructions to the microprocessor 16. The timer 34 provides a time period during which the microprocessor 16 will instruct the voice module 24 to repeat the alarm voice warnings and a time duration the microprocessor 16 will instruct the voice module 24 to sound the siren. For example, the timer 34 can set the time period duration from a range of two (2) minutes to ten (10) minutes. For example, if the timer 34 is set to a time period of five (5) minutes and the alarm control unit 10 receives a signal from a triggering device (discussed herein below with respect to the functions of the portable deterrent alarm system), the microprocessor 16 will instruct the voice module 34 to repeat the voice alarm for five (5) minutes. Additionally, the internal siren 26 and external siren 28 will broadcast the siren noise for a duration of five (5) minutes.

The alarm control unit 10 includes a power supply 36. The power supply 36 provides a connection, via an extension cord 38 and Alternating Current (AC) plug 40, to an electrical source (not illustrated). When the plug 40 is connected (inserted into) to an AC outlet, 120 volt power is provided to the power supply 36. The alarm control unit 10 is powered through an alternating source current, typically 120 volts at 60 hz, through the standard electrical plug 40. The electrical plug 40 is connected to a power transformer in the power supply 36 that transforms the 120 volt, 60 hz AC current to a 12 volt DC (direct current). The alarm control unit 10 can operate on 12 volt DC.

The power supply 36 is electrically connected to the alarm control board 14. The alarm control board 14 can distribute electrical current (and voltage) to devices coupled to the alarm control board 14 (i.e., the voice module 24, the internal siren 26, external siren 28, keypad 30, keypad remote 32, and timer 34). Alternatively, the power supply 36 can be electrically connected to each of the devices of the alarm control unit 10. Stated another way, the power supply 36 can be individually electrically connected to the alarm control board 14, the voice module 24, the internal siren 26, the external siren 28, the keypad 30, the keypad remote 32, and the timer 34. As such, the power supply 36 delivers electrical current (and voltage) to the alarm control board 14, the voice module 24, the internal siren 26, the external siren 28, the keypad 30, the keypad remote 32, and the timer 34.

In another embodiment, the alarm control unit 10 includes a battery backup 42. The battery backup 42 is electrically connected to the power supply 36. The power supply 36 can include circuitry necessary to charge the battery backup 42. Therefore, the power supply 36 can recharge the battery backup 42 after any use or as necessary. Alternatively, instead connecting to the power supply 36, the battery backup 42 could be electrically connected to the alarm control board 14 as well as the power supply 36 (for charging of the battery backup 42). Additionally, instead of being connected to the power supply 36, the battery backup 42 could be electrically connected to the alarm control board 14, the voice module 24, the internal siren 26, the external siren 28, the keypad 30, the keypad remote 32, and the timer 34. The battery backup 42 provides an alternate power source in the event of an interruption of electrical energy (current and voltage) from the AC source (i.e., via the extension cord 38 and plug 40). The battery backup 42 can be able to detect the interruption of electrical energy and, in response to the detection of the interruption, the battery backup 42 can supply the electrical energy to the portable deterrent alarm system. The battery backup 42 can provide electrical energy to the portable deterrent alarm system for a period from two (2) days up to two (2) weeks depending upon the size and type of battery backup used. Artisans of skill will appreciate that many types of battery backups can be used and the portable deterrent alarm system is not limited to the use of any particular battery backup system.

As stated hereinabove, the alarm control unit 10 may include a voice module 24 for broadcasting a voice alarm. In order to broadcast the voice alarm, the voice module 24 is electrically and data coupled, such that data can be communicated, to a voice speaker 44 (illustrated in FIG. 2). The voice speaker 44 can draw electrical energy from the voice module 24 or the voice speaker can be electrically connected to the power supply 36. The voice module 24 can also be electrically connected to the battery backup 42 in a manner consistent with the other devices. For example, if the other devices (the alarm control board 14, the voice module 24, the internal siren 26, the external siren 28, the keypad 30, the keypad remote 32, and the timer 34) are connected to the battery backup 42, the voice speaker 44 may be electrically connected to the battery backup 42. However, if the other devices (the alarm control board 14, the voice module 24, the internal siren 26, the external siren 28, the keypad 30, the keypad remote 32, and the timer 34) are only connected to the power supply 36, the voice speaker 44 can be connected only to the power supply 36. The voice speaker 44 can be mounted inside a housing (reference number 50 described herein below with respect to FIG. 2) of the portable deterrent system, or the voice speaker 44 can be mounted externally at a location within the construction site. For example, the voice speaker 44 can be mounted on the top of a temporary wall, in the ceiling, on a construction trailer, or on the perimeter of the construction site. Artisans of skill will appreciate that these are exemplary locations only and that many other variations are possible. When mounted externally at a location within the construction site, the voice speaker 44 can be electrically coupled to the voice module 24 via a peripheral cable (reference number 82 described herein below with respect to FIG. 2). Additionally, more than one voice speaker 44 can be coupled to the voice module 24.

In one embodiment, the portable deterrent alarm system includes a video camera 46 (shown in FIG. 2). The camera 46 can be electrically and data coupled to alarm control unit 10. The camera 46 can be electrically coupled to the power supply 36 and battery backup 42 in the manner described herein above with respect to the other portable deterrent alarm system components (i.e., the voice module 24, the internal siren 26, external siren 28, keypad 30, keypad remote 32, and timer 34). The camera 46 can be a color infrared camera that can record images between five (5) frames per second up to thirty (30) frames per second. The camera 46 can be a still frame camera with a motion sensor that captures still images of an object or person that triggers the motion sensor. Alternatively, the camera 46 can be an IP camera (i.e. an Internet Camera). The camera 46 can be reactive to a change in pixilation of a viewing area captured by the camera 46. For example, the camera 46 can be positioned to capture the images of a particular room. When something, or someone, enters the room, the pixels of the image captured by the camera will change. As a result, the camera 46 can activate an output terminal on the camera 46 to transmit the currently viewed image (i.e., the image of the room with the something or someone contained therein). The camera 46 can be data coupled to the alarm control unit 10 and a digital video recorder (“DVR”) 48. As such, the microprocessor 16 can turn the camera 46 on (i.e. into a viewing mode awaiting a change in pixilation) when the portable deterrent alarm system is armed. Additionally, the microprocessor 16 can turn the camera 46 off when the portable deterrent alarm system is disarmed. Further, the microprocessor 16 can be responsive to receiving a signal from the output of the camera 46 that a change in pixilation has occurred (or that an image has been captured by the motion sensitive still frame camera). Therefore, the microprocessor 16, in response to receiving the signal from the camera 46, can initiate a series of functions as defined by the programmed instructions in the memory 18. For example, the microprocessor 16 may sound an alarm siren, sound a voice alarm, initiate a telephone communication to a monitoring center, or a combination of these. Artisans of skill will appreciate that the microprocessor 16 can perform many more functions as defined by the programming instructions.

The camera 46 can also transmit, via the output terminal, the image (i.e., the image of the room with the something or someone contained therein) to the DVR 48. The DVR 48 can be a four channel DVR. The DVR 48 can be electrically coupled to the power supply 36 and battery backup 42 in the manner described herein above with respect to the other portable deterrent alarm system components (i.e., the voice module 24, the internal siren 26, the external siren 28, the keypad 30, the keypad remote 32, and the timer 34). The DVR 48 can be electrically coupled to the alarm control unit 10 such that, in response to the camera 46 transmitting an image on the output terminal, the microprocessor 16 activates the DVR 48. The DVR 48 can be electrically coupled to the camera 46 such that, in response to the camera 46 detecting a change in the pixilation of the viewing area, the camera 46 activates the DVR 48. The DVR 48, when activated, is able to record all the images transmitted from the output terminal of the camera 46. The DVR 48 may be capable of recording still and moving images as well as audio recordings. The DVR 48 may contain a data hard-disc large enough to capture 2 weeks worth of continuous video recording. The DVR 48 can be set to record images received over a user specified period of time ranging from one (1) day up to two (2) weeks. The user can program the DVR 48 recording period through either the internal keypad 30 or remote keypad (described herein above). When the recording period is programmed into the DVR 48, the DVR 48 will retain all images received, when activated by the camera 46 or microprocessor 16, for the programmed period of time. The DVR 48 will delete images as the recorded date becomes older than the period of time specified. For example, if the user programs the period of time to be seven (7) days, the DVR 48 will retain the image for seven (7) days and delete the image on the eighth (8^{th}) day. It should be noted that the DVR 48 may not be continually on during the seven (7) days. The DVR 48 could be in an off state and only record images when activated by the camera 46 or microprocessor 16.

In an alternate embodiment, the camera 46 can be positioned anywhere in the construction site and can be mounted on a stand (not shown) with a mechanism to rotate the camera 46 into different viewing angles and areas. In such configuration, the camera 46 would be wirelessly coupled to the DVR 48. Additionally in such configuration, the camera 46 could be connected to separate power supply and electrical power source or an independent power source.

The DVR 48 is data coupled to the alarm control unit 10. The microprocessor 16 is able to activate the DVR 48 and cause the DVR 48 to play back the images stored on the DVR 48 hard disc. For example, when the alarm control unit 10 microprocessor receives a signal from a triggering device that an intrusion has occurred, the microprocessor 16 can initiate a telephone communication to a monitoring center and can transmit the images being stored on the DVR 48. Additionally, rather than transmitting the images via a telephone communication, a user may access the stored images by connecting an output terminal to a viewing monitor (not shown) to view the stored images.

In an alternate embodiment, the camera 46 transmits all images captured in the viewing area. The camera 46 transmits the images via an output on the camera 46 to the DVR 48. The DVR 48 can contain programming in a DVR memory and DVR microprocessor such that the DVR 48 can detect a change in pixilation of the capture image of the viewing area. In response to the detection of the change in pixilation, the DVR 48 commences a recording operation to record the images transmitted by the camera 46.

In an additional embodiment, the alarm control unit 10 can include a tamper detection switch (not shown). In the event that a criminal attempts to tamper with the alarm control unit 10 in an effort to disable the portable deterrent alarm system, the alarm control unit 10 can be equipped with a tamper detection switch. The tamper detection switch can be electrically coupled to the internal siren 26 and can be data coupled to the microprocessor 16 on the alarm control board 14. The internal siren 26 and voice speaker 44 can be triggered to sound whenever the tamper detection switch has been tripped.

In an alternate embodiment, either the camera 46 or the DVR 48, or both, can also be coupled to the telephone communication device 20 and backup wireless telephone device 22. The camera 46 or the DVR 48, or both, can be capable of connecting, via a telephone communication, to the internet via a specified Internet Protocol (IP) address and transmitting the images captured by the camera 46 or the contents of the DVR 48.

Additionally, the alarm control unit 10 can also contain a Global Positioning System device (GPS) 54. The GPS 54 can transmit signals indicating the location of the alarm control unit 10. Additionally, the GPS 54 can be programmed to respond with a GPS data indicating a geographic location upon receipt of a specific signal received from the user. The microprocessor 16 can also include the GPS data as part of the information transmitted via the telephone communication to the monitoring center.

Referring now to FIG. 2, an exemplary block diagram of a portable deterrent alarm system in accordance with some embodiments of the invention is shown. The portable deterrent alarm system includes a housing structure 50, such as a box or barrel. The housing 50 can have a top side, a bottom side, a front side, a back side, a right side and a left side. The housing 50 can have a lid 56, forming the top side of the housing, pivotally attached at a hinge joint connected at the top, back side of the housing 50. The housing can also have a user handle 60 just below the hinge joint 58 or as part of the hinge joint 58. The housing can vary in size as required to contain the various components of the portable deterrent alarm system. For example the housing 50 can be a size ranging from a height (as measured from the ground) of thirty-six inches (36″) to forty-two inches (42″); and a square width and depth of between twenty inches by twenty inches (20″×20″) to twenty-five inches by twenty-five inches (25″×25″). The housing 50 can include a pair of wheels 62 attached at an axle member to the bottom, back side of the housing 50. The inclusion of the handle 60 and wheels 62 provides the user the ability to readily relocate the portable deterrent alarm system from one location to another. An anchoring chain 64, with lock, can be provided to secure the portable deterrent alarm system to a specific location. For example, a user can drill an anchor into a concrete slab and lock the chain 64 with a lock into the anchor thereby anchoring the portable deterrent alarm system. This anchoring feature could assist in preventing an individual from relocating the portable deterrent system without proper authority (i.e., a key from the user). In an alternate embodiment, a series of weights (not shown) can be placed inside the housing (at the base or bottom) to provide such additional weight as to assist in preventing an individual from relocating the portable deterrent alarm system. The weight added could be in the range of 50 pounds to 200 pounds. Removal of the weights can be hampered through the use of a locking pin (reference number 66 discussed herein below) that secures the lid 56 in a closed position.

As stated hereinabove, the housing 50 should be of a size sufficient to enclose the various components of the portable deterrent alarm system. The alarm control unit 10 can be detachably connected one interior side of the housing 50. The DVR 48 can be detachably connecting to a second interior side of the housing 50. The voice speaker 44 can be attached on the interior bottom side the housing 50. Additionally, sound openings 68 can be made through one of the sides of the housing 50 such that the openings 68 are in front of the voice speaker 44 and allow a clear broadcast of the voice alarm from the voice speaker 44 out of the housing 50 through the openings 68. The camera 46 can be attached on the interior of the front side of the housing 50. The camera 46 is attached such that the lense of the camera 46 is aligned with a viewing port 70 extending through the front side of the housing 50. The viewing port 70 allows the camera to be placed on the interior side of the housing 50 while still retaining the ability to capture images outside the housing 50. An additional mounting point 72 can be included on a remaining interior side of the housing 50. The additional mounting point 72 can be used to detachably connect another component such as, for example, the backup wireless telephone device 22. As such, the housing 50 can contain the alarm control unit 10, the camera 46, the DVR 48, and the backup wireless telephone device 22.

Attached to the housing structure 50, in one embodiment, is a strobe tower 74. The strobe tower 74 extends from within the housing 50 though an opening in the lid 56 of housing 50. The strobe tower 74 can be attached to the bottom interior of the housing 50 or to any of the interior sides of the housing 50. The strobe tower 74 can be constructed of two differently sized conduit so as to render the strobe tower 74 adjustable in height from a lowest position wherein the smaller conduit is almost fully contained within the larger conduit to a highest position wherein the smaller conduit is almost fully protruding from the larger conduit. For example, the strobe tower 74 can include a first conduit that is 2¼″ in diameter and that is connected to another conduit that is 2″ in diameter. The two conduits are connected to form a telescoping conduit structure that can vary in height from five feet (5′) to eight feet (8′). Artisans of skill will appreciate that the sizes are exemplary and that many variations are possible and that a varying range of extension positions from lowest to highest positions, and multiple settings in between can be used.

The strobe tower 74 can include a locking pin 66 to lock the strobe tower at a particular position. The two conduits of the strobe tower 74 could contain holes extending perpendicular to the conduit length such that, as the holes line up between the interior conduit (smaller conduit) and exterior conduit (larger conduit), the locking pin 66 can be inserted through the holes in order to lock the position. The locking pin 66 includes a locking mechanism such that, once inserted, enables locking pin 66 to be locked in place and only removed through the use of a key. Furthermore, insertion of the locking pin 66 and the locking operation therefore results in the prevention of the lid 56 from being opened since the strobe tower 74 extends through an opening in the lid 56 and the locking pin 66 is placed in a position adjacent to the lid 56. Placement of the locking pin 66 near the lid 56 such that the lid 56 cannot be opened when the locking pin 66 is inserted assists in the prevention of access to the components of the portable deterrent alarm system contained within the housing 50.

Attached to a top end of the strobe tower 74 is a junction box 76. Attached to the junction box 76 can be a pair of strobe lights 78. The strobe lights 78 can be blue, amber, or clear in color. The strobe lights 78 are electrically coupled to the alarm control unit 10. The strobe lights 78 can be coupled such that, upon arming of the portable deterrent alarm system, the strobe lights 78 are in an on state. Additionally, the strobe lights 78 can be connected such that the strobe lights 78 are turned on by the alarm control unit 10 in response to the alarm control unit 10 receiving a triggering signal from an alarm triggering device. The external siren 28 can be attached to the junction box 76. A three-hundred-sixty degree (360°) motion sensor 80 can be attached to the junction box 76. The motion sensor 80 can be electrically coupled to the alarm control unit 10. A series of motion sensors may be used in place of a 360 degree motion sensor 80.

A peripheral cable 82 can extend from the alarm control unit 10 via a channel within the strobe tower 74 through an opening at the top end of the strobe tower 74. The peripheral cable 82 is connected at one end to the alarm control unit 10. The other end of the peripheral cable 82 extends from the strobe tower 74 and is adapted for connection to a plurality of triggering devices. The triggering devices can include, but are not limited to, motion sensors, window sensors, door sensors, infrared sensors, sound detectors, smoke alarms, or any other alarm triggering sensor as is currently known in the art or developed in the future. The peripheral cable 82 provides for a connection between the triggering devices and the alarm control unit 10. Additionally, the peripheral cable 82 can be connected to triggering devices that are installed during construction but are planned to remain as part of the permanent security system that will be in use when the building is completed.

In an additional embodiment, a fog unit 84 can be included as part of the portable deterrent system. The fog unit 84 can be placed inside the housing structure 50. Additionally, the fog unit 84 can also be placed anywhere within the construction site and coupled to the alarm control unit 10 via the peripheral cable 82. The fog unit 84, when activated, emits a fog or smoke to fill an area the fog, or smoke, so as to make the area, and articles therein, more difficult to see. The alarm control unit 10 can contain additional instructions within the memory 18 so as to cause the microprocessor 16 to activate the fog unit 84 in the event that the microprocessor 16 receives a signal from a triggering device indicating an intrusion has occurred. If the fog unit 84 is placed inside the housing 50, the housing 50 would have a plurality of vent holes (not illustrated) positioned around the housing 50 to enable the fog to emanate from the fog unit 84 through the vent holes in order to fill the area with an emitted fog.

The portable deterrent alarm system is operable to record all motions and video recordings once armed. An arming switch 86 can be provided on the exterior of the housing 50. The arming switch 86 can be electrically and data coupled, such that data can be communicated, to the alarm control unit 10. The arming switch 86 can transition the alarm control unit 10 from a disarmed state to an armed state. Additionally, the arming switch 86 can transition the alarm control unit to a full off state. In a disarmed state, the alarm control unit 10 can be receiving electrical energy from the power supply 36 or the battery backup 42. Additionally, the components (i.e. the voice module 24, the internal siren 26, the external siren 28, the keypad 30, the telephone connection device 20 and backup wireless telephone device 22, the keypad remote 32, the timer 34, the camera 46, the DVR 48, the GPS 54, and the fog unit 84) can be tested. Further, the images stored on the disc of the DVR 48 can be viewed (when coupled to a monitor). When in an armed stated, the alarm control unit 10 is ready to receive signals from an attached triggering device (described herein above) and perform the functions as directed by the programming (i.e., functions caused by the instructions stored in memory 18). When in a full off state, the alarm control unit 10 and all components receive no electrical energy from either the power supply 36 or battery backup 42. In an alternate embodiment, two separate arming switches 86 can be provided. The first arming switch 86 can transition the portable deterrent alarm system from an full off state to an on state wherein the second arming switch 86 can arm and disarm the portable deterrent alarm system.

The housing 50 includes a spool 88 to store the extension cord 38. The extension cord 38 extends from the power supply 36 of the alarm control unit 10 through the back side of the housing 50. The extension cord can vary in length from twenty-five feet (25′) to one-hundred feet (100′). Artisans of skill can appreciate the lengths are exemplary and many other lengths of extension cord can be used.

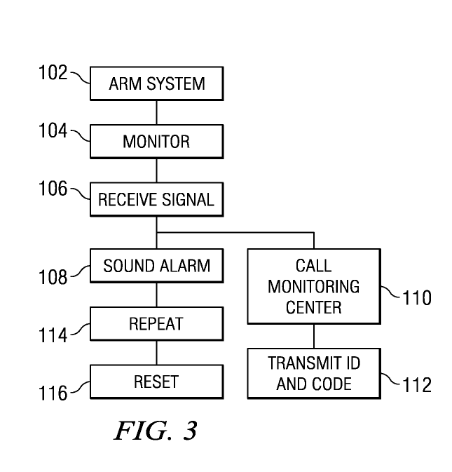

As stated herein above, the plurality of instructions stored in the memory 18 are configured to cause the microprocessor 16 to perform a series of functions. FIG. 3 illustrates an exemplary flow chart of the operations performed by the portable deterrent alarm system. When armed at step 102, the microprocessor 16 enters a monitoring mode at step 104. In the monitoring mode, the microprocessor 16 monitors the various connections to determine if a trigger signal is received from one of the triggering devices. If one of the triggering devices is tripped, the triggering device sends the trigger signal to the alarm control unit 10 and, ultimately, to the microprocessor 16 at step 106. For example, if a motion sensor 80 detects a motion, the motion sensor can send a signal indicated such to the microprocessor 16. The microprocessor 16 can be programmed to wait a specified period of time in order to allow an authorized user to disarm the system. The microprocessor 16 can, while waiting the specified period of time to be disarmed, can instruct the voice module 24 to broadcast a “chirp” from the internal siren 26 and external siren 28. Alternatively, the microprocessor 16 can be programmed to have no “wait period.” Such programming could occur, for example, in a case where a remote keypad is used to arm and disarm the system.

When the “wait period” has elapsed, or immediately upon receiving the trigger signal if no “wait period” is programmed, at step 108 the microprocessor 16 instructs the voice module 24 to broadcast a voice alarm via the speaker 44, to broadcast a siren via one or both of the internal and external sirens 26, 28. The microprocessor 16 may also instruct the camera 46 and DVR 48 to start recording all images captured. The microprocessor 16 may instruct the fog unit 84, if so equipped, to emit fog. The microprocessor 16 could, at substantially the same time at step 110, initiate a telephone communication to the monitoring center via the telephone communication device 20. Upon establishing the telephone communication, the microprocessor 16 could transmit an event code indicating that an intruder has been detected. At step 112, the microprocessor 16 could transmit a different event code for different triggering events, such as intruder, fire, power loss, or damage to the unit. The microprocessor 16 could also transmit a unique unit identifier, such as a unique unit number, SIM card number, or phone number. Optionally, the microprocessor 16 could transmit GPS data indicating the geographic location of the portable deterrent alarm system unit. The microprocessor 16 would repeat the alarms, voice and siren, until the timer 34 duration elapsed 114. Thereafter, the microprocessor 16 would return to step 116 to a monitoring mode until receiving another trigger signal from the same triggering device or any other triggering device.

Upon receiving a call from the microprocessor 16, the monitoring center would receive the unit identifier and code transmitted from the microprocessor 16. Therefore, the monitoring center would be able to identify which unit had called and what type of event was occurring. The monitoring center could then either contact the property owner, construction company representative, the police, the fire department, or any combination thereof.

Upon completion of the construction, the portable deterrent alarm, if contained within an in-wall box can be left to become the permanent security system. Alternatively, the in-wall box can be removed and a permanent security system optionally installed. Alternatively, if contained with the housing 50, the peripheral cable 82 can be disconnected from the triggering devices. The triggering devices may be left to become part of the permanent security system or retrieved. The portable deterrent alarm system, as contained by the housing 50, can, thereafter, be readily relocated to another construction site.

It will be appreciated by those skilled in the art having the benefit of this disclosure that this Theft Buster—Portable Alarm Deterrent System provides a alarm deterrent system that is readily transportable to various locations and adaptable to be secured at a desired location. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A portable theft deterrent alarm system for construction sites and remote areas, said portable theft deterrent system comprising:
a housing;
an alarm control unit positioned inside said housing;
a video camera coupled to said alarm control unit; wherein said camera is detachably connected on a first interior side of said housing and adapted to transmit an output image of a viewing area via an opening on a front side of said housing;
a digital video recorder (DVR), detachably connected on a second interior side of said housing, data coupled to said video camera and said alarm control unit, wherein said DVR is adapted to record said output image from said video camera;
a motion sensor data connected to said alarm control unit;
a speaker data connected to said alarm control unit; and
a peripheral cable adapted for connection on a first end to a plurality of alarm triggering devices; wherein at least one of said plurality of alarm triggering devices is attached at a remote location from said housing and said peripheral cable is connected on a second end to said alarm control unit;
wherein, in response to a trigger signal received from at least one of said motion sensor or one of said plurality of alarm triggering devices, said alarm control unit is adapted to perform at least one of, calling a monitoring center via a telephone communication, sounding a siren alarm, and sounding a voice alarm.

2. The theft deterrent system of claim 1, wherein said alarm control unit comprises:
an alarm control board;
a voice module data coupled to said alarm control board;
an internal siren electrically coupled to said voice module;
a keypad controller data coupled to said alarm control board;
a power source electrically coupled to said alarm control board; and
an external remote controller data coupled to said alarm control board, wherein said external remote controller is adapted for data connection with an external keypad controller.

3. The theft deterrent system of claim 2, wherein said alarm control unit further comprising:
a timer electrically connected to said alarm control board, wherein said alarm control board is adapted to repeat an operation cycle for a duration of time specified by said timer.

4. The theft deterrent system of claim 2, wherein said alarm control board comprises:
a microprocessor;
a computer readable medium in data communication with said microprocessor;
a telephone communication interface data coupled to said microprocessor; and
a plurality of instructions wherein at least a portion of said plurality of instructions are storable in said computer readable medium, and further wherein said plurality of instructions are configured to cause said microprocessor to perform the steps of:
receiving said trigger signal;
sending a voice alarm signal to said voice module, wherein said voice module transmits a recorded voice via said speaker;
sending a siren signal to said voice module, wherein said voice module activates said internal siren;
establishing a telephone communication with a monitoring location; and
transmitting a code to said monitoring location via said telephone communication.

5. The theft deterrent system of claim 4, wherein said telephone communication is a wireless communication.

6. The theft deterrent system of claim 4, wherein said telephone communication is a plain old telephone system (POTS) communication.

7. The theft deterrent system of claim 6, further comprising a backup wireless telephone communication device, wherein said alarm control unit is adapted to establish a wireless communication connection with a monitoring station upon a failure to establish a connection via said telephone communication.

8. The theft deterrent system of claim 4, wherein said alarm control board further comprises:
a Global Positioning System (GPS) device data connected to said microprocessor;
and wherein said plurality of instructions is further configured to cause said microprocessor to transmit a GPS data in the step of transmitting.

9. The theft deterrent system of claim 1, wherein said video camera is adapted to detect a change in a pixilation of said viewing area.

10. The theft deterrent system of claim 9, wherein upon said detection of said change in said pixilation of said viewing area, said alarm control unit transmits a signal to said DVR to record said output image.

11. The theft deterrent system of claim 1, wherein said DVR is adapted to detect a change in a pixilation of said viewing area.

12. The theft deterrent system of claim 1, further comprising:
a strobe tower protruding from a top-side of said housing, wherein said motion detector is attached to a top end of said strobe tower, said strobe tower having a channel extending from a bottom end to said top end, and wherein said peripheral cable extends from said second connection via said channel through said top end;
a strobe light attached to said top end of said strobe tower, wherein said strobe light is electrically connected to said power source; and
an external siren electrically connected to said voice module.

13. The theft deterrent system of claim 10, further comprising a second strobe light attached to said top end of said strobe tower, wherein said strobe light is electrically connected to said power source.

14. The theft deterrent system of claim 1, wherein said housing comprises:
a first wheel located at a right rear bottom side of said housing;
a second wheel located at a left rear bottom side of said housing;
a user handle extending from said top rear side of said housing; and
a lid pivotally connected via a hinge at said top rear side of said housing.

15. The theft deterrent system of claim 1, further comprising a fog emitter inside said housing, said fog emitter electrically connected to said alarm control unit, wherein upon receiving said trigger signal, said alarm control unit is further adapted to activate said fog emitter.

16. A method for providing theft deterrent at construction and remote sites, the method comprising:
providing alarm system in a portable housing, the alarm system comprising:
an alarm control unit,
a motion sensor,
an interface for connection to a plurality of triggering devices,
a motion sensitive video camera,
a digital video recorder, and
a wireless telephone communication device;
receiving, by the alarm control unit, the triggering signal from at least one of the plurality of triggering devices;
initiating a voice alarm;
initiating a telephone communication to a monitoring center; and
transmitting to the monitoring center, a unique identifier and an event code, wherein the unique identifier uniquely identifies the alarm system.

17. The method of claim 16, further comprising transmitting to the monitoring center information identifying a geographic location of the alarm system.

18. The method of claim 17, wherein the information identifying the geographic location includes a GPS data.

19. A theft deterrent alarm system for construction sites and remote areas, said theft deterrent system comprising:
a housing, said housing comprising:
a main compartment,
a lid pivotally hinged to a rear side of said main compartment,
a pair of wheels on a lower rear side,
a power cable spool,
a lock-down chain and lock, and
a user handle on an upper rear side, wherein said handle provides a user the ability to readily relocate said theft deterrent system;
a strobe tower detachably connected to an internal side of said housing, wherein said strobe tower is adaptable to be adjusted in height from a first position to a second position and wherein said strobe tower is connected to said internal side of said housing through said lid;
a locking pin adaptable for placing in a locking hole of said strobe tower, wherein upon insertion of said locking pin into said hole of said strobe tower, said strobe tower is locked in at least one of said first position or said second position and said lid is locked in a closed position;
an alarm control unit, said alarm control unit comprising:
a microprocessor on an alarm control board,
a memory on said alarm control board, wherein said memory is data coupled to said microprocessor,
a wireless modem electrically coupled to said microprocessor,
a keypad controller data coupled to said microprocessor,
a voice module electrically coupled to said microprocessor,
an internal siren electrically coupled to said voice module,
a timer electrically coupled to said microprocessor, and
a battery backup electrically coupled to said alarm control board, wherein said battery backup is adapted to power said theft deterrent system upon the occurrence of an electrical power interruption;
a video camera data coupled to said microprocessor on a first connection;
a digital video recorder data coupled, on an input connection, to a second connection of
said video camera and data coupled, on an output connection, to said microprocessor;
a cable bus electrically coupled on a first end to said microprocessor and a second end adapted for connection to a peripheral device; wherein said cable bus terminates at said second end outside said housing via said strobe tower;
a strobe light attached to a top end of said strobe tower, wherein said strobe light is electrically coupled to said microprocessor;
a motion sensor attached to a top end of said strobe tower, wherein said motion sensor is electrically coupled to said microprocessor;
an external siren electrically coupled to said voice module; and
an electrical power plug electrically coupled to said alarm control board.
